(19) United States
(12) Patent Application Publication
(10) Pub. No.: US 2005/0047181 A1
(43) Pub. Date: Mar. 3, 2005

(54) Power supply apparatus

(76) Inventors: Isao Yamamoto, Ukyo-Ku (JP); Tomoyuki Ito, Ukyo-Ku (JP)

Correspondence Address: CANTOR COLBURN LLP, 55 Griffin Road South, Bloomfield, CT, 06002, US

(21) Appl. No.: 10/928,375

(22) Filed: Aug. 27, 2004

(30) Foreign Application Priority Data
Aug. 29, 2003 (JP) JP2003-307175

(51) Int. Cl. H02M 3/18

(52) U.S. Cl. 363/60

(57) ABSTRACT

A boosting converter boosts a battery voltage by a charge pump circuit and then outputs a boosted voltage. A detected output voltage of the charge pump circuit is fed back to a regulator circuit. A reference voltage comparator compares the detected output voltage with a reference voltage and, according to the comparison result, performs an ON/OFF control of a transistor, thereby adjusting the power from the battery voltage and supplying it as an input voltage to the charge pump circuit. A power supply voltage comparator compares a detected battery voltage with a reference battery voltage. According to the comparison result, the power supply voltage comparator sends a boosting rate select signal to the charge pump circuit, thereby switching the boosting rate of the charge pump.

### BACKGROUND OF THE INVENTION

1. Field of the Invention

The present invention relates to power supply apparatuses which supply device drive voltage by boosting power supply voltage.

2. Description of the Related Art

In battery-driven portable equipment, such as cellular phones or PDAs (personal digital assistants), LED (light-emitting diode) elements are used for a variety of purposes, which include use as a backlight for an LCD (liquid crystal display), as a flash for an attached CCD (charge coupled device) camera or as an illumination with the LED elements flashing in different emission colors. To drive such LED elements, it is necessary to supply a drive voltage, which is a battery voltage of about 3.6 V supplied from a lithium ion battery or the like boosted to about 4.5 V. Furthermore, when the battery voltage has dropped due to the battery drain or when the voltage drops significantly due to an increased load current flowing to the LED elements, it is necessary to boost the battery voltage at a higher boosting rate.

Therefore, a power supply apparatus for driving such devices as LED elements is required to generate a drive voltage therefor by boosting the battery voltage at an appropriate boosting rate in response to the existing operating environment. For example, Reference (1) in the following Related Art List discloses a drive voltage supply unit which includes a boosting circuit provided with multiple stages of boosting capacitors, added with a selector switch for selecting a necessary boosting capacitor for a desired boosting rate and an external select terminal, coupled to the selector switch, for selecting the boosting rate.

Related Art List

(1) Japanese Patent Application Laid-Open No. Hei06-78527.

The drive voltage supply unit of Reference (1) operates on a system such that an output of a power supply voltage detection circuit is first supplied to CPU, where the boosting rate is determined by software processing, and then a boosting rate select signal from the CPU is inputted to an external select terminal of the unit. Thus, when software control is utilized for the switching of boosting rates like this, it is necessary to provide the power supply with an external terminal for use with control signals. And such an arrangement results in a reduced degree of design freedom for circuit integration by placing limitation on the use of IC pins.

### SUMMARY OF THE INVENTION

The present invention has been made in view of the foregoing circumstances and an object thereof is to provide a power supply apparatus capable of automatically setting the boosting rate of power supply voltage internally without relying on a control signal from outside.

A preferred embodiment according to the present invention relates to a power supply apparatus. This power supply apparatus includes: a boosting circuit which boosts power supply voltage at a preset boosting rate and outputs drive voltage of a device; a regulator circuit which adjusts input voltage to the boosting circuit in order for a detected voltage of an output line in the boosting circuit to be equal to a reference voltage; a power supply voltage detecting circuit which detects the power supply voltage supplied to the regulator circuit; and a boosting rate switching circuit which supplies, based on the detected power supply voltage, a signal by which to switch the boosting rate to the boosting circuit, wherein the boosting circuit, the regulator circuit, the power supply voltage detecting circuit and the boosting rate switching circuit are monolithically integrated. The boosting circuit may be structured in a manner such that the boosting rate is switchable in multiple stages. The boosting rate switching circuit may send to the boosting circuit a signal by which to switch the boosting rate stepwise.

Another preferred embodiment according to the present invention relates also to a power supply apparatus. This power supply apparatus includes: a boosting circuit which boosts power supply voltage at a preset boosting rate and outputs drive voltage of a device; a regulator circuit which adjusts input voltage to the boosting circuit in order for a detected voltage of an output line in the boosting circuit to be equal to a reference voltage; a terminal voltage detecting circuit which detects terminal voltage of the device which is connected to an output terminal of the boosting circuit as a load; and a boosting rate switching circuit which supplies, based on the detected terminal voltage, a signal by which to switch the boosting rate to the boosting circuit, wherein the boosting circuit, the regulator circuit, the terminal voltage detecting circuit and the boosting rate switching circuit are monolithically integrated.

Still another preferred embodiment according to the present invention relates also to a power supply apparatus. This power supply apparatus includes: a boosting circuit which boosts power supply voltage at a preset boosting rate and outputs drive voltage of a device; a regulator circuit which adjusts input voltage to the boosting circuit in order for a detected voltage of an output line in the boosting circuit to be equal to a reference voltage; a load current detecting circuit which detects load current of the device which is connected to an output terminal of the boosting circuit as a load; and a boosting rate switching circuit which supplies, based on the detected load current, a signal by which to switch the boosting rate to the boosting circuit, wherein the boosting circuit, the regulator circuit, the load current detecting circuit and the boosting rate switching circuit are monolithically integrated.

Still another preferred embodiment according to the present invention relates also to a power supply apparatus. This power supply apparatus includes: a boosting circuit which boosts power supply voltage at a preset boosting rate and outputs drive voltage of a device; a regulator circuit which adjusts input voltage to the boosting circuit in order for a detected voltage of an output line in the boosting circuit to be equal to a reference voltage; a power supply voltage detecting circuit which detects the power supply voltage supplied to the regulator circuit; a load current detecting circuit which detects load current of the device which is connected to an output terminal of the boosting circuit as a load; and a boosting rate switching circuit which supplies, based on at least one of the detected power supply voltage and the detected load current, a signal by which to switch the boosting rate to the boosting circuit, wherein the boosting circuit, the regulator circuit, the power supply voltage detecting circuit, the load current detecting circuit and the boosting rate switching circuit are monolithically integrated.

By employing a power supply apparatus according to any of the above preferred embodiments, a physical quantity that leads to a cause for switching a boosting rate of power supply voltage in a boosting circuit is detected by a detection circuit provided within the power supply apparatus and, based on the detected results, a boosting rate of the boosting circuit can be switched by a switching circuit provided within the power supply apparatus. Thus, it is not necessary to perform a switching control from outside of the power supply apparatus. The physical quantities to be detected as causes for switching the boosting rate of the boosting circuit include power supply voltage, terminal voltage and load current of a device which is connected as a load, and so forth. The power supply apparatus can automatically switch the boosting rate according to these detected values or quantities. In a power supply apparatus according to any of the embodiments, the detection circuit, the switching circuit and the boosting circuit are all monolithically integrated, so that no software processing for switching the boosting rate is required and the provision of a terminal through which a boosting rate switching signal is inputted externally is no longer required in the power supply apparatus.

It is to be noted that any arbitrary combination of the above-described structural components and expressions changed between a method, an apparatus, a system and so forth are all effective as and encompassed by the present embodiments.

Moreover, this summary of the invention does not necessarily describe all necessary features so that the invention may also be sub-combination of these described features.

### BRIEF DESCRIPTION OF THE DRAWINGS

FIG. 1 illustrates a structure of a boosting converter according to a first embodiment of the present invention.

FIG. 2 illustrates a structure of a charge pump circuit shown in FIG. 1.

FIG. 3 illustrates ON/OFF states of switches when the boosting rate of charge pump circuit shown in FIG. 2 is set to 1 time.

FIG. 4 illustrates ON/OFF states of switches at the time of the charging when the boosting rate of charge pump circuit shown in FIG. 2 is set to 1.5 times.

FIG. 5 illustrates ON/OFF states of switches at the time of the discharging when the boosting rate of charge pump circuit shown in FIG. 2 is set to 1.5 times.

FIG. 6 illustrates ON/OFF states of switches at the time of the charging when the boosting rate of charge pump circuit shown in FIG. 2 is set to 2 times.

FIG. 7 illustrates ON/OFF states of switches at the time of the discharging when the boosting rate of charge pump circuit shown in FIG. 2 is set to 2 times.

FIG. 8 illustrates a structure of a boosting converter according to a second embodiment of the present invention.

FIG. 9 illustrates a structure of a voltage detection circuit shown in FIG. 8.

FIG. 10 illustrates a structure of a boosting converter according to a third embodiment of the present invention.

FIG. 11 illustrates a structure of a current detection circuit shown in FIG. 10.

FIG. 12 illustrates a structure of a boosting converter according to a fourth embodiment of the present invention.

### DETAILED DESCRIPTION OF THE INVENTION

The invention will now be described based on the following embodiments which do not intend to limit the scope of the present invention but exemplify the invention. All of the features and the combinations thereof described in the embodiments are not necessarily essential to the invention.

A power supply apparatus according to an embodiment of the present invention includes, in a monolithically integrated system, a boosting circuit so structured as to be able to change the boosting rate of power supply voltage, a detection circuit for detecting a physical quantity which serves as the basis for switching the boosting rate of power supply voltage, and a switching circuit for performing a switching control of the boosting rate for the boosting circuit based on the detection result. The structure and operation for a power supply apparatus according to the present invention will be hereinbelow described based on embodiments.

First Embodiment

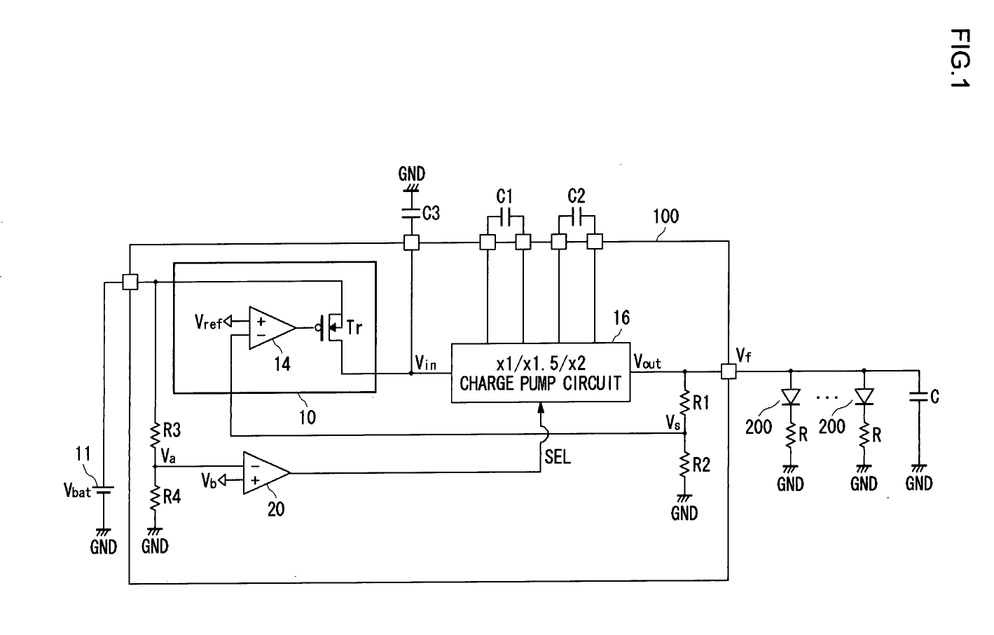

FIG. 1 illustrates a structure of a boosting converter 100 according to a preferred embodiment of the present invention. A circuit constituting a boosting converter 100 is monolithically integrated as a power supply apparatus. The boosting converter 100 receives an input voltage, which is a battery voltage Vbat from a lithium ion battery 11, and boosts it, in a charge pump system, at a charge pump circuit 16, which uses boosting capacitors C1 and C2, and thereby outputs a boosted voltage Vf. A plurality of LED elements 200, together with a smoothing capacitor C, are connected in parallel to the output terminal of the boosting converter 100 and are each grounded via a resistor R. A boosted voltage Vf outputted from the boosting converter 100 is supplied to these LED elements 200. The battery voltage Vbat of the lithium ion battery 11, which is about 3.6 V, normally takes a value in a range of 3.0 V to 4.2 V. The boosting converter 100 boosts the battery voltage Vbat to a boosted voltage Vf of 4.5 to 5 V and supplies it to each of the parallel-connected LED elements 200 as a drive voltage.

The charge pump circuit 16 outputs an output voltage Vout by boosting an input voltage Vin at a preset boosting rate, which is effected by selectively charging or discharging the boosting capacitors C1 and C2 through the ON and OFF operations of the internally provided transistors serving as switches. A detected output voltage Vs, which is obtained by dividing an output voltage Vout of the charge pump circuit 16 with two voltage-dividing resistors R1 and R2, is fed back to a regulator circuit 10. A reference voltage comparator 14 in the regulator circuit 10 compares the reference voltage Vref from a reference voltage source with the detected output voltage Vs of the charge pump circuit 16 for the level difference and, according to the comparison result, performs an ON/OFF control of a transistor Tr, thereby adjusting the power from the battery voltage Vbat and supplying it as an input voltage Vin to the charge pump circuit 16 via a smoothing capacitor C3. In this manner, the input voltage Vin to the charge pump circuit 16 is so regulated as to zero the difference between the detected output voltage Vs and the reference voltage Vref.

A power supply voltage comparator 20 compares a detected battery voltage Va, which is obtained by dividing an battery voltage Vbat with two voltage-dividing resistors R3 and R4, with a reference battery voltage Vb for the level difference. And if the detected battery voltage Va is lower than the reference battery voltage Vb, the power supply voltage comparator 20 sends an H-level signal as a boosting rate select signal SEL to the charge pump circuit 16, or if it is not, the power supply voltage comparator 20 sends an L-level signal as a boosting rate select signal SEL thereto. In response to the boosting rate select signal SEL, the charge pump circuit 16 boosts the input voltage Vin by switching the boosting rate to 1 time, 1.5 times or 2 times. Suppose, for instance, that the reference battery voltage Vb has been set at 3.4 V and the detected battery voltage Va has dropped below 3.4 V due to the consumption of the lithium ion battery 11. Then the boosting rate select signal SEL from the power supply voltage comparator 20 will go high (H-level) and the boosting rate for the charge pump circuit 16 will be switched from 1.5 times to 2 times. Also, suppose that the detected battery voltage Va has risen above 3.4 V due to the charging of the lithium ion battery 11, then the boosting rate select signal SEL from the power supply voltage comparator 20 will go low (L-level) and the boosting rate for the charge pump circuit 16 will be switched from 2 times to 1.5 times.

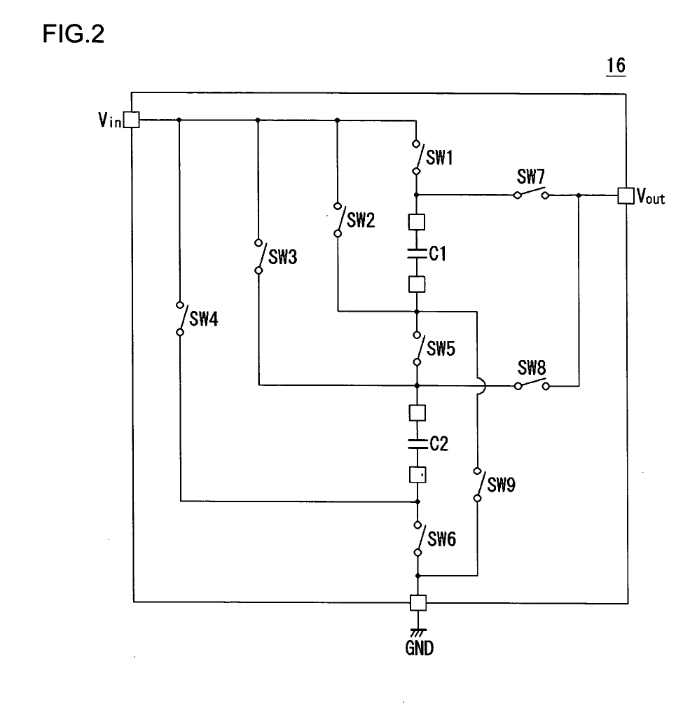

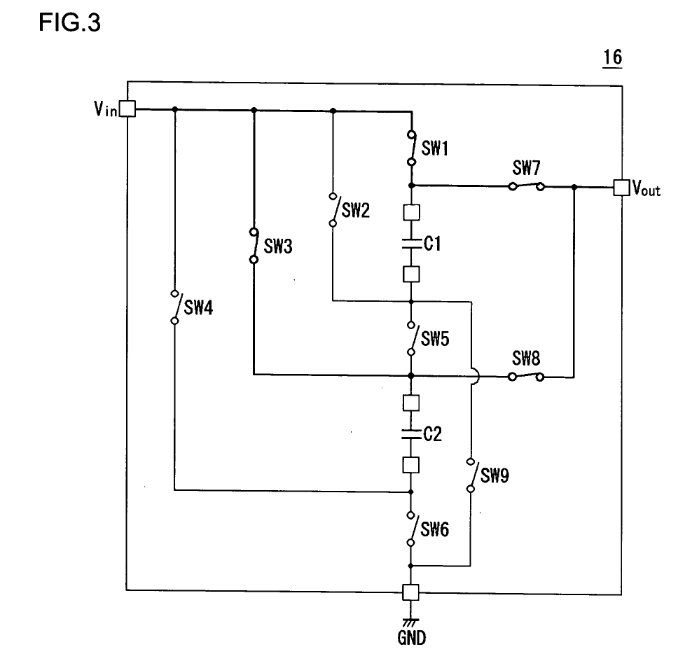

FIG. 2 illustrates a structure of a charge pump circuit 16. The charge pump circuit 16 boosts an input voltage Vin to an output voltage Vout by performing ON/OFF control of first to ninth switches SW1 to SW9 according to a preset boosting rate and thereby switching both the connection mode and the timing of charging or discharging of two boosting capacitors C1 and C2. FIG. 3 illustrates the ON/OFF states of the first to ninth switches SW1 to SW9 when the boosting rate is 1 time. As is shown in FIG. 3, the first switch SW1, the third switch SW3, the seventh switch SW7 and the eighth switch SW8 are each placed in the ON position and the other switches in the OFF position, so that the input voltage Vin is outputted just as it is as the output voltage Vout.

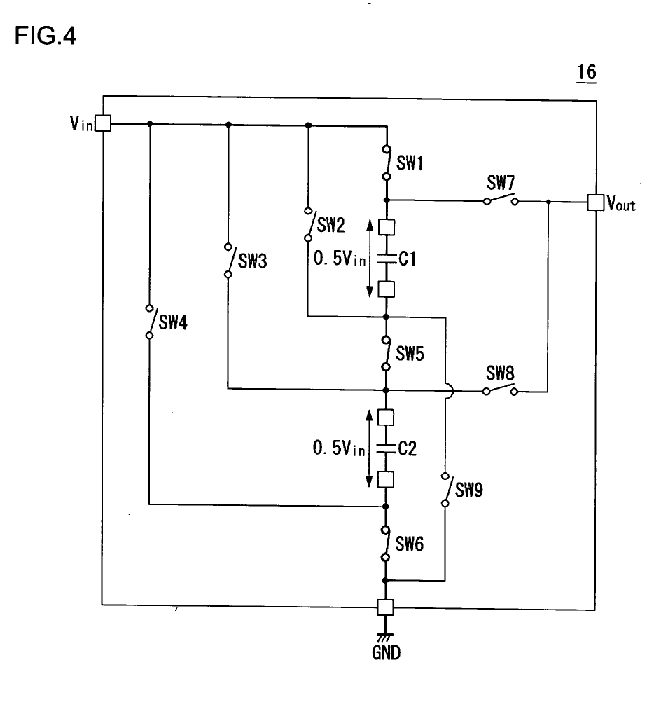

Next, the case where the boosting rate is 1.5 times is explained below. FIG. 4 illustrates the ON/OFF states of the first to ninth switches SW1 to SW9 for the first timing of switching. For the first timing, the charge pump circuit 16 places the first switch SW1, the fifth switch SW5 and the sixth switch SW6 in the ON position and the other switches in the OFF position, so that a circuit with the two boosting capacitors C1 and C2 connected in series is formed and thereby the boosting capacitors C1 and C2 are charged with power of the input voltage Vin until the second timing arrives. In this manner, a voltage 0.5 Vin is applied across each of the two boosting capacitors C1 and C2.

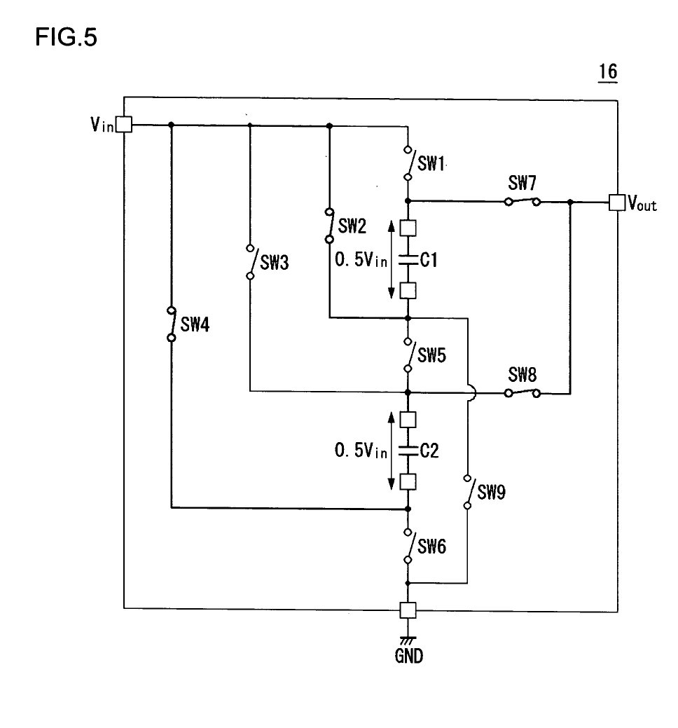

FIG. 5 illustrates the ON/OFF states of the first to ninth switches SW1 to SW9 for the second timing of switching. For the second timing, the charge pump circuit 16 switches the three switches SW1, SW5 and SW6, having been switched ON for the first timing, to the OFF position and the second, fourth, seventh and eighth switches SW2, SW4, SW7 and SW8 to the ON position, so that the two boosting capacitors C1 and C2 are now connected in parallel and thereby an input voltage Vin is applied, in the direction opposite to that for charging, to the boosting capacitors C1 and C2 charged with the voltage of 0.5 Vin. Thus the two boosting capacitors C1 and C2 are discharged and a power is supplied to the output terminal. In this manner, the voltage 0.5 Vin of the two boosting capacitors C1 and C2 is added to the input voltage Vin, so that the output voltage Vout becomes 1.5 Vin.

The charge pump circuit 16 repeats the charging and discharging of the two boosting capacitors C1 and C2 by alternately repeating the ON/OFF states of the first to ninth switches SW1 to SW9 for the first and the second timing and thereby outputs an output voltage Vout, which is an input voltage Vin boosted 1.5 times.

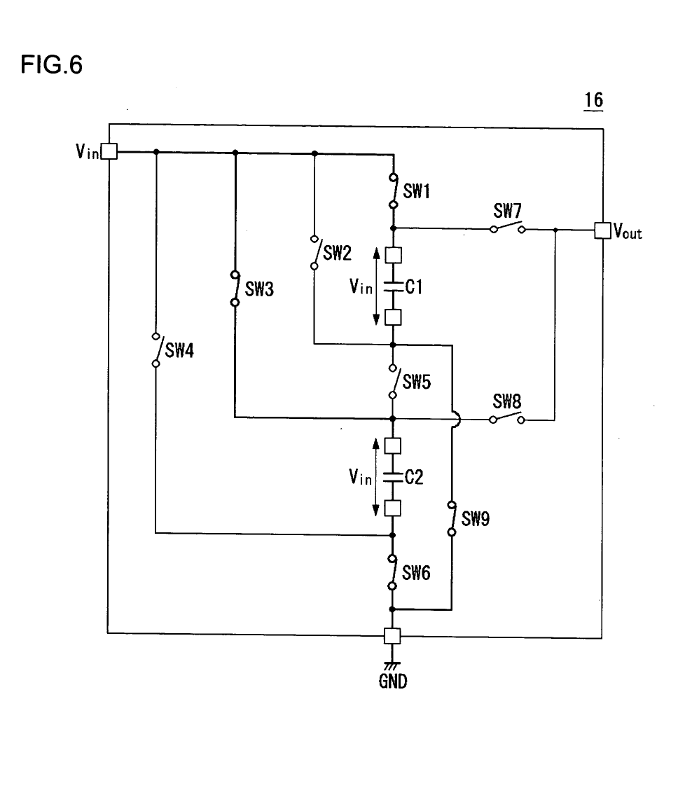

Next, the case where the boosting rate is 2 times is explained below. FIG. 6 illustrates the ON/OFF states of the first to ninth switches SW1 to SW9 for the first timing of switching. For the first timing, the charge pump circuit 16 places the first switch SW1, the third switch SW3, the sixth switch SW6 and the ninth switch SW9 in the ON position and the other switches in the OFF position, so that a circuit with the two boosting capacitors C1 and C2 connected in parallel is formed and thereby the boosting capacitors C1 and C2 are charged with power of the input voltage Vin until the second timing arrives. In this manner, a voltage of Vin is applied across each of the two boosting capacitors C1 and C2.

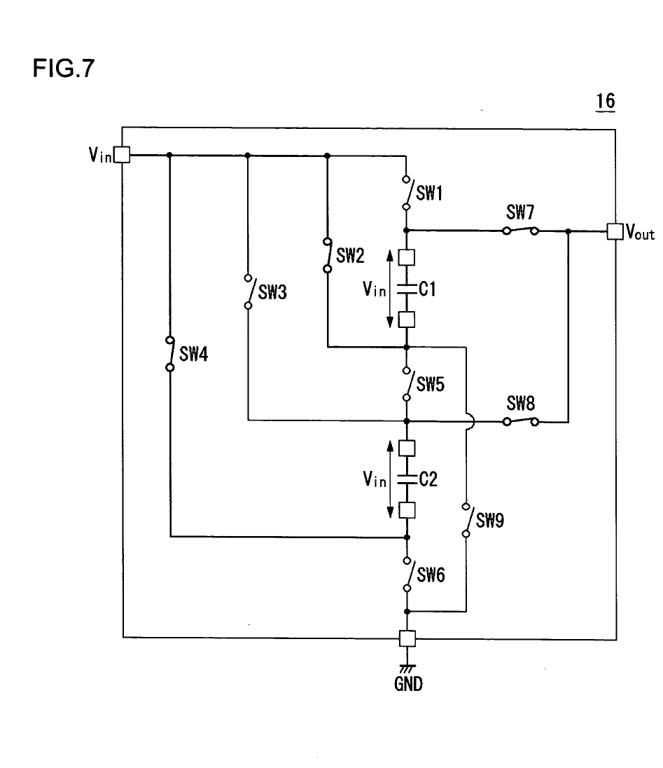

FIG. 7 illustrates the ON/OFF states of the first to ninth switches SW1 to SW9 for the second timing of switching. For the second timing, the charge pump circuit 16 switches the four switches SW1, SW3, SW6 and SW9, having been switched ON for the first timing, to the OFF position and the second, fourth, seventh and eighth switches SW2, SW4, SW7 and SW8 to the ON position, so that the two boosting capacitors C1 and C2 are connected in parallel and thereby an input voltage Vin is applied, in the direction opposite to that for charging, to the boosting capacitors C1 and C2 charged with the voltage of Vin. Thus the two boosting capacitors C1 and C2 are discharged and a power is supplied to the output terminal. In this manner, the voltage Vin of the two boosting capacitors C1 and C2 is added to the input voltage Vin, so that the output voltage Vout becomes 2.0 Vin.

The charge pump circuit 16 repeats the charging and discharging of the two boosting capacitors C1 and C2 by alternately repeating the ON/OFF states of the first to ninth switches SW1 to SW9 for the first and the second timing and thereby outputs an output voltage Vout, which is an input voltage Vin boosted 2 times.

Second Embodiment

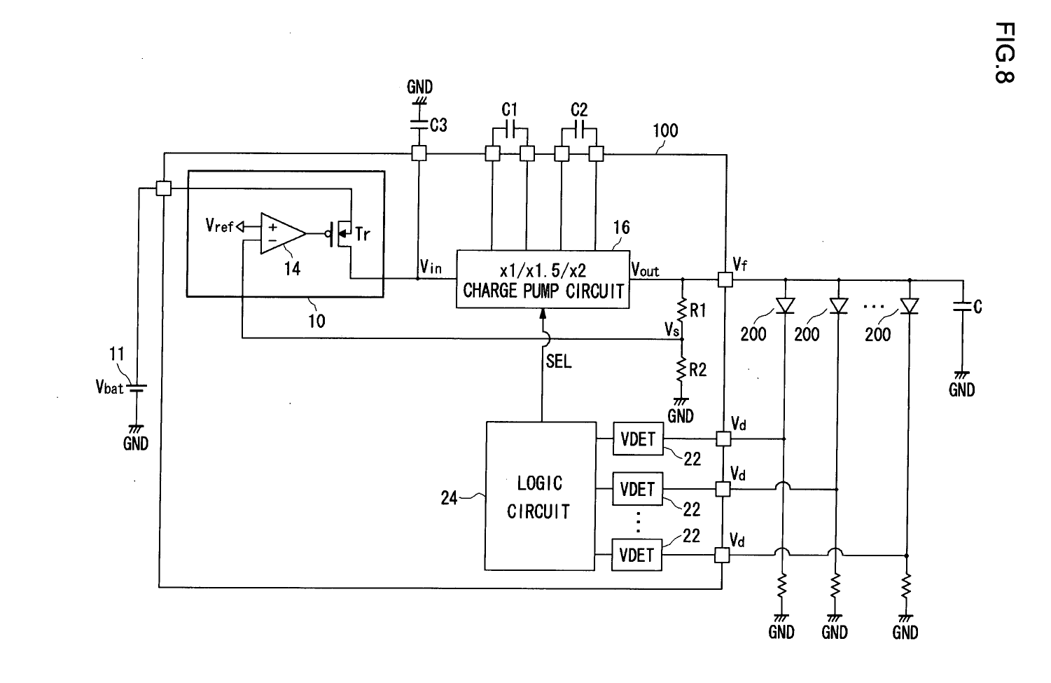

FIG. 8 illustrates a structure of a boosting converter 100 according to a second embodiment of the present invention. The boosting converter 100 according to this embodiment is a monolithically integrated power supply apparatus which comprises a charge pump circuit 16, which is capable of switching the boosting rate, voltage detection circuits (VDET) 22, which detect the respective terminal voltages Vd of a plurality of LED elements 200 connected as loads to the output terminal of the boosting converter 100, and a logic circuit 24, which switches the boosting rate for the charge pump circuit 16 in response to the detected terminal voltages.

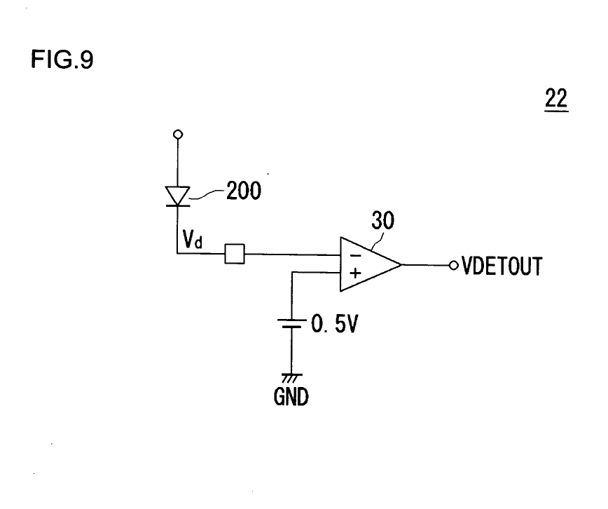

FIG. 9 illustrates a structure of a voltage detection circuit 22. A comparator 30 compares a terminal voltage Vd of an LED element 200 with a reference voltage of 0.5 V and outputs an H-level output signal VDETOUT when the terminal voltage is 0.5 V or below.

Referring back to FIG. 8, the logic circuit 24 performs logical operation of the output signals VDETOUT from a plurality of voltage detection circuits 22 and supplies the result thereof to the charge pump circuit 16 as a boosting rate switching signal SEL. For example, the logic circuit 24 calculates a logical sum of a plurality of output signals VDETOUT and outputs an H-level boosting rate switching signal SEL when at least one of the output signals VDETOUT is high (H-level).

The logic circuit 24 may perform a majority logical operation of a plurality of output signals VDETOUT and may output an H-level boosting rate switching signal SEL when a predetermined count or more of the output signals VDETOUT is high (H-level). Also, the logic circuit 24 may perform a logical operation by weighting the output signals VDETOUT according to the emission colors of the LED elements 200. In this manner, a drop in the terminal voltage of an LED element 200 of a specific color may be evaluated according to the weighting and the boosting rate may be raised accordingly. Moreover, the logical operation by the logic circuit 24 may be so structured that it is rewritable from outside.

The boosting converter 100 according to the present embodiment is such that when the terminal voltage of the LED elements 200 drops due to a drop in the battery voltage Vbat or a like cause, the voltage detection circuit 22 automatically detects the drop in the terminal voltage and the logic circuit 24 can raise the boosting rate for the charge pump circuit 16.

Third Embodiment

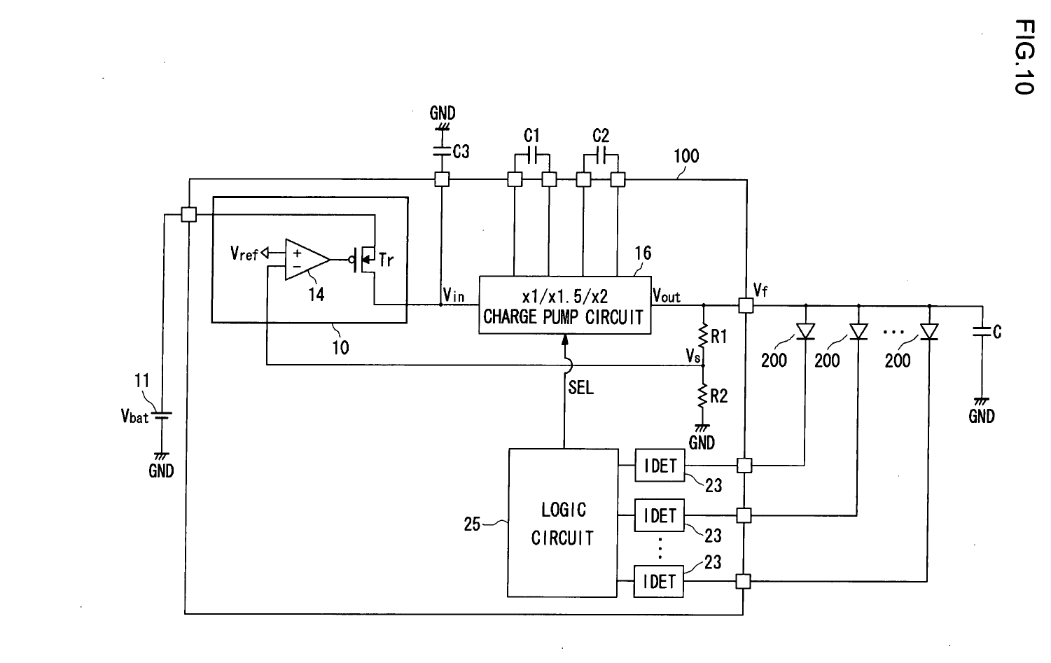

FIG. 10 illustrates a structure of a boosting converter 100 according to a third embodiment of the present invention. The boosting converter 100 according to this embodiment is a monolithically integrated power supply apparatus which comprises a charge pump circuit 16, which is capable of switching the boosting rate, current detection circuits (IDET) 23, which detect the respective load currents Id of a plurality of LED elements 200 connected as loads to the output terminal of the boosting converter 100, and a logic circuit 25, which switches the boosting rate for the charge pump circuit 16 in response to the detected load currents.

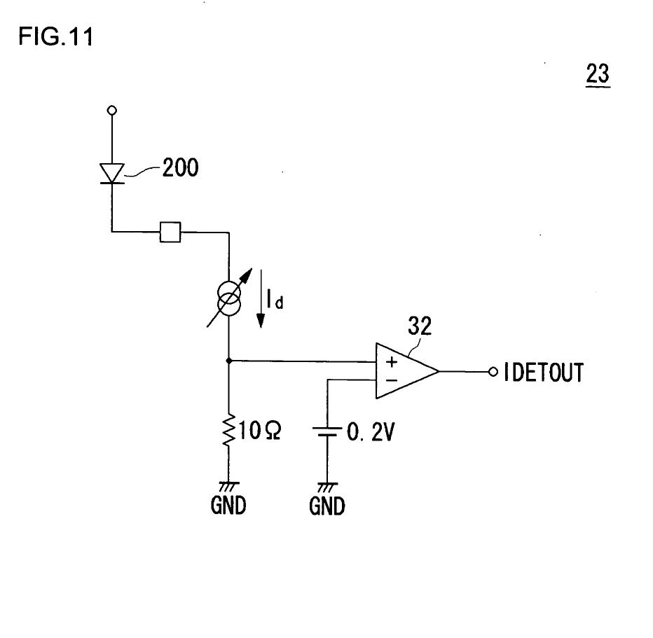

FIG. 11 illustrates a structure of a current detection circuit 23. A comparator 32 compares a detected voltage with a reference voltage of 0.2 V and outputs an H-level output signal IDETOUT when the detected voltage exceeds 0.2 V. Here, the detected voltage is a voltage detected when the load current Id of an LED element 200 flows through a resistor of 10 Ω. That is, when the load current Id of the LED element 200 exceeds a prescribed value of 20 mA, the output signal IDETOUT goes high (H-level).

Referring back to FIG. 10, the logic circuit 25 performs logical operation of the output signals IDETOUT from a plurality of current detection circuits 23 and supplies the result thereof to the charge pump circuit 16 as a boosting rate switching signal SEL. For example, the logic circuit 25 performs the calculation of a logical sum or majority logic operation on a plurality of output signals IDETOUT and outputs an H/L-level boosting rate switching signal SEL based on the operation result.

For example, when a large load current Id is sent to an LED element 200 in order for this LED element to illuminate with increased intensity, the drive voltage may drop with a voltage drop. In the boosting converter 100 according to the present embodiment, the voltage detection circuit 22 automatically detects the load current Id that exceeds a prescribed value and the logic circuit 25 raises the boosting rate of the charge pump circuit 16, so that a drop in the drive voltage of the LED element 200 can be prevented.

Fourth Embodiment

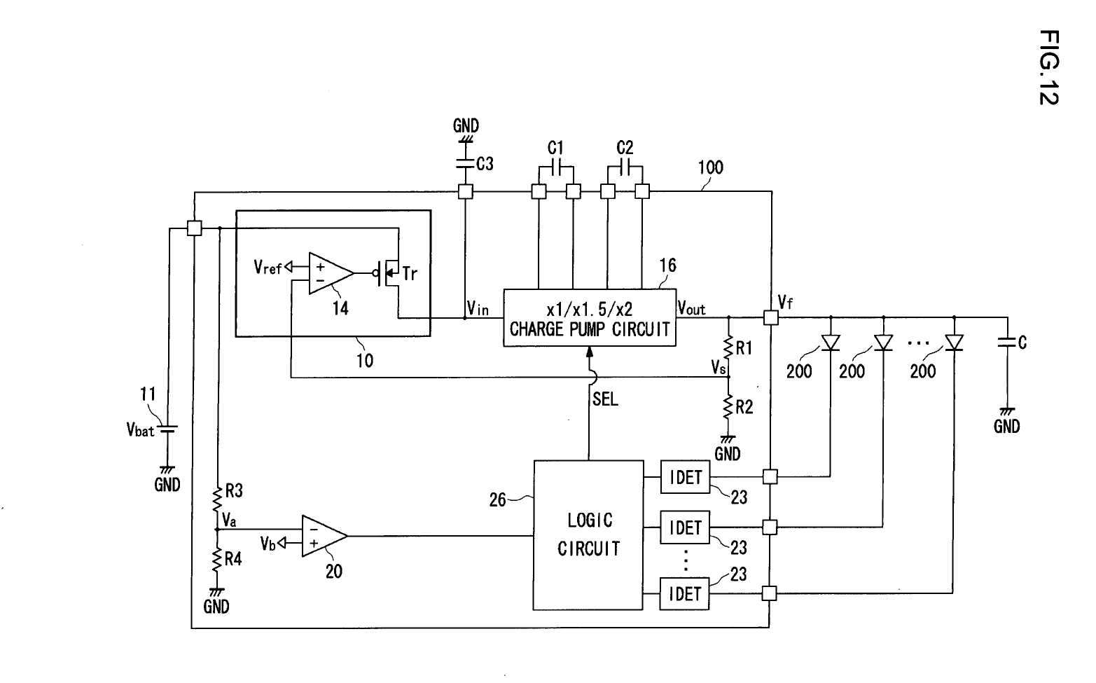

FIG. 12 illustrates a structure of a boosting converter 100 according to a fourth embodiment of the present invention. The boosting converter 100 according to this embodiment is such that a structure of a power supply voltage comparator 20 in the boosting converter 100 shown in FIG. 1 is combined with a structure of current detection circuits 23 in the boosting converter 100 shown in FIG. 10. And a detection result of power supply voltage Vbat by the power supply voltage comparator 20 and detection results of load current Id of the LED elements 200 by the current detection circuits 23 are evaluated by a predetermined logic operation in the logic circuit 26, so that a boosting rate switching signal SEL is fed to the charge pump circuit 16. For example, the logic circuit 26 determines a value of the boosting rate switching signal SEL by calculating the logical sum or majority logic of the output of the power supply voltage comparator 20 and the outputs of the current detection circuits 23.

In the boosting converter 100 according to the present embodiment, the drop in the battery voltage Vbat and the rise in the load current Id of the LED elements 200 are evaluated in a combined manner, so that the boosting rate of the charge pump circuit 16 can be automatically switched.

The present invention has been described based on the embodiments, and the above first to fourth embodiments are only exemplary. It is therefore understood by those skilled in the art that there exist other various modifications to the combination of each component and process described above and that such modifications are also encompassed by the scope of the present invention.

In general, the boosting rate of a charge pump circuit is determined by switching structures of boosting capacitors. The switching structures or switching factors include the number of boosting capacitors and the mode of switching connection thereof, the number of boosting steps and so forth. In the present embodiment, the description of a structure is given where there are two boosting capacitors in a charge pump circuit and the boosting rate is switched among those of 1 time, 1.5 times and 2 times. However, these are only exemplary and are not limited thereto and the structure has a flexible degree of freedom, so that the number of boosting capacitors and the range of switchable boosting rates differ depending on a design.

The boosting converter according to the present embodiments boosts the input voltage by a switching method, and described therein are exemplary structures such that the power supply voltage is boosted by a charge pump circuit using boosting capacitors. A structure may be such that the power supply voltage is boosted by a boosting chopper circuit using coils. The boosting chopper circuit boosts the power supply voltage by alternately repeating the charging of energy to the coils and the discharging of energy from the coils.

In the present embodiments, description is given of a structure such that when LED elements connected in parallel are to be driven, the boosting rates are switched by detecting the terminal voltage and load current of each LED element. A structure may be such that when LED elements connected in series are to be driven, the boosting rates are switched by detecting the terminal voltage and load current across the LED elements connected in series and comparing the detected values with prescribed values.

Although in the present embodiments the LED elements are used as an example of devices which are connected to the power supply apparatus, such a device may also be other elements or devices such as an organic electro-luminescence device and so forth.

Although the present invention has been described by way of exemplary embodiments, it should be understood that many changes and substitutions may further be made by those skilled in the art without departing from the scope of the present invention which is defined by the appended claims.

1. A power supply apparatus including:
a boosting circuit which boosts power supply voltage at a preset boosting rate and outputs drive voltage of a device;
a regulator circuit which adjusts input voltage to said boosting circuit in order for a detected voltage of an output line in said boosting circuit to be equal to a reference voltage;
a power supply voltage detecting circuit which detects the power supply voltage supplied to said regulator circuit; and
a boosting rate switching circuit which supplies, based on the detected power supply voltage, a signal by which to switch the boosting rate to said boosting circuit,
wherein said boosting circuit, said regulator circuit, said power supply voltage detecting circuit and said boosting rate switching circuit are monolithically integrated.

2. A power supply apparatus according to claim 1, wherein said boosting circuit is structured in a manner such that the boosting rate is switchable in multiple stages and wherein said boosting rate switching circuit sends to said boosting circuit a signal by which to switch the boosting rate stepwise.

3. A power supply apparatus according to claim 2, wherein when the detected power supply voltage becomes lower than a predetermined reference voltage, said boosting rate switching circuit sends to said boosting circuit a switching signal to raise the boosting rate.

4. A power supply apparatus according to claim 2, wherein when the detected power supply voltage becomes higher than a predetermined reference voltage, said boosting rate switching circuit sends to said boosting circuit a switching signal to lower the boosting rate.

5. A power supply apparatus according to claim 2, wherein said boosting circuit boosts the power supply voltage at the boosting rate by selectively charging or discharging a plurality of boosting capacitors.

6. A power supply apparatus including:
a boosting circuit which boosts power supply voltage at a preset boosting rate and outputs drive voltage of a device;
a regulator circuit which adjusts input voltage to said boosting circuit in order for a detected voltage of an output line in said boosting circuit to be equal to a reference voltage;
a terminal voltage detecting circuit which detects terminal voltage of the device which is connected to an output terminal of said boosting circuit as a load; and
a boosting rate switching circuit which supplies, based on the detected terminal voltage, a signal by which to switch the boosting rate to said boosting circuit,
wherein said boosting circuit, said regulator circuit, said terminal voltage detecting circuit and said boosting rate switching circuit are monolithically integrated.

7. A power supply apparatus according to claim 6, wherein said terminal voltage detecting circuit detects terminal voltage of each of a plurality of devices connected to the output terminal of said boosting circuit as a load and wherein said boosting rate switching circuit includes: a plurality of comparators which compare the terminal voltage of each of the devices with a predetermined threshold value; and a logic circuit which evaluates outputs from the plurality of comparators by a predetermined logic operation and which, based on the evaluation result, supplies a signal by which to switch the boosting rate to said boosting circuit.

8. A power supply apparatus according to claim 7, wherein said boosting circuit is structured in a manner such that the boosting rate is switchable in multiple stages and wherein said boosting rate switching circuit sends to said boosting circuit a signal by which to switch the boosting rate stepwise.

9. A power supply apparatus according to claim 8, wherein when at least one of the terminal voltages detected in the plurality of devices becomes lower than a predetermined reference voltage, said boosting rate switching circuit sends to said boosting circuit a switching signal to raise the boosting rate.

10. A power supply apparatus according to claim 8, wherein said boosting circuit boosts the power supply voltage at the boosting rate by selectively charging or discharging a plurality of boosting capacitors.

11. A power supply apparatus including:
a boosting circuit which boosts power supply voltage at a preset boosting rate and outputs drive voltage of a device;
a regulator circuit which adjusts input voltage to said boosting circuit in order for a detected voltage of an output line in said boosting circuit to be equal to a reference voltage;
a load current detecting circuit which detects load current of the device which is connected to an output terminal of said boosting circuit as a load; and
a boosting rate switching circuit which supplies, based on the detected load current, a signal by which to switch the boosting rate to said boosting circuit,
wherein said boosting circuit, said regulator circuit, said load current detecting circuit and said boosting rate switching circuit are monolithically integrated.

12. A power supply apparatus according to claim 11, wherein said load current detecting circuit detects load current of each of a plurality of devices connected to the output terminal of said boosting circuit as a load and wherein said boosting rate switching circuit includes: a plurality of comparators which compare the load current of each of the devices with a predetermined threshold value; and a logic circuit which evaluates outputs from the plurality of comparators by a predetermined logic operation and which, based on the evaluation result, supplies a signal by which to switch the boosting rate to said boosting circuit.

13. A power supply apparatus according to claim 12, wherein said boosting circuit is structured in a manner such that the boosting rate is switchable in multiple stages and wherein said boosting rate switching circuit sends to said boosting circuit a signal by which to switch the boosting rate stepwise.

14. A power supply apparatus according to claim 13, wherein when at least one of the load currents detected in the plurality of devices exceeds a prescribed value, said boosting rate switching circuit sends to said boosting circuit a switching signal to raise the boosting rate.

15. A power supply apparatus according to claim 13, wherein said boosting circuit boosts the power supply voltage at the boosting rate by selectively charging or discharging a plurality of boosting capacitors.

16. A power supply apparatus including:
a boosting circuit which boosts power supply voltage at a preset boosting rate and outputs drive voltage of a device;
a regulator circuit which adjusts input voltage to said boosting circuit in order for a detected voltage of an output line in said boosting circuit to be equal to a reference voltage;
a power supply voltage detecting circuit which detects the power supply voltage supplied to said regulator circuit;
a load current detecting circuit which detects load current of the device which is connected to an output terminal of said boosting circuit as a load; and
a boosting rate switching circuit which supplies, based on at least one of the detected power supply voltage and the detected load current, a signal by which to switch the boosting rate to said boosting circuit,
wherein said boosting circuit, said regulator circuit, said power supply voltage detecting circuit, said load current detecting circuit and said boosting rate switching circuit are monolithically integrated.

17. A power supply apparatus according to claim 16, wherein said boosting circuit is structured in a manner such that the boosting rate is switchable in multiple stages and wherein said boosting rate switching circuit sends to said boosting circuit a signal by which to switch the boosting rate stepwise.

18. A power supply apparatus according to claim 17, wherein when the detected power supply voltage becomes lower than a predetermined reference voltage or when the detected load current exceeds a prescribed value, said boosting rate switching circuit sends to said boosting circuit a switching signal to raise the boosting rate.

19. A power supply apparatus according to claim 17, wherein said boosting circuit boosts the power supply voltage at the boosting rate by selectively charging or discharging a plurality of boosting capacitors.
